(19) United States
(12) Patent Application Publication
(10) Pub. No.: US 2024/0088736 A1
(43) Pub. Date: Mar. 14, 2024

(54) METHOD FOR FORMING A STATOR WINDING, ANNULAR LAMINATED CORE, AND ELECTRIC MOTOR

(71) Applicant: Brose Fahrzeugteile SE & Co. Kommanditgesellschaft, Würzburg, Würzburg (DE)

(72) Inventors: Wolfgang Strauss, Unterpleichfeld (DE); Alexander Volkamer, Oberscheinfeld (DE)

(21) Appl. No.: 18/513,886

(22) Filed: Nov. 20, 2023

Related U.S. Application Data
(63) Continuation of application No. PCT/EP2022/063556, filed on May 19, 2022.

(30) Foreign Application Priority Data
May 21, 2021 (DE) 10 2021 205 244.4

(51) Int. Cl. H02K 3/28; H02K 1/14; H02K 15/02

(52) U.S. Cl. CPC H02K 3/28; H02K 1/145; H02K 15/026

(57) ABSTRACT

A stator winding of an annular laminated core for an electric motor. A stator lamination of the annular laminated core is equipped with an insulating end disc, on which a plurality of terminating domes are formed protruding in the axial direction. Stator teeth that project in the radial direction are wound with a winding wire, forming a coil in each case. The winding wire between two coils assigned to the same phase and/or for contacting the or each correspondingly assigned coil with motor electronics is laid on the insulating end disc. In addition to a number of fixing loops each laid around a terminating dome for fixing the winding wire, the winding wire is laid radially outside and also radially inside the terminating domes.

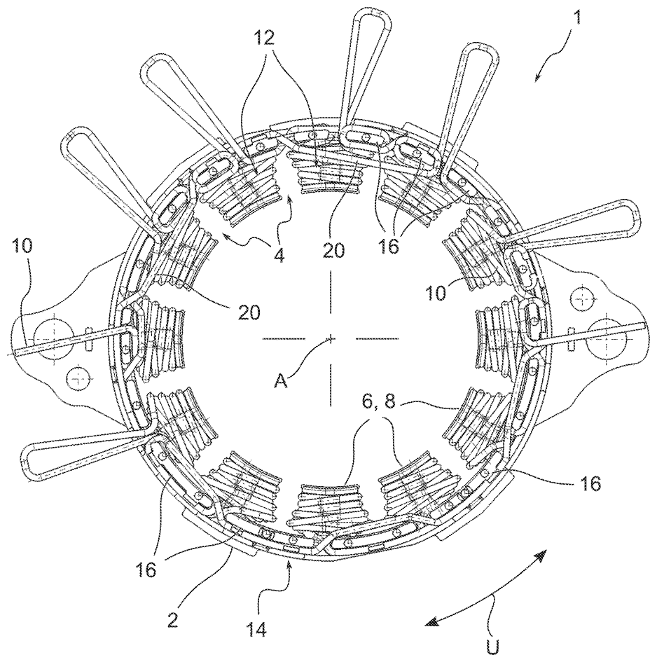

### CROSS-REFERENCE TO RELATED APPLICATION

This application is a continuation, under 35 U.S.C. § 120, of copending International Patent Application PCT/EP2022/063556, filed May 19, 2022, which designated the United States; this application also claims the priority, under 35 U.S.C. § 119, of German Patent Application DE 10 2021 205 244.4, filed May 21, 2021; the prior applications are herewith incorporated by reference in their entirety.

### FIELD AND BACKGROUND OF THE INVENTION

The invention concerns a method for forming a stator winding of an annular laminated core for an electric motor. The invention furthermore concerns such an annular laminated core and an electric motor.

An annular laminated core stator is usually a stator which is formed from a laminated core in which the individual laminations are annularly closed. So-called (stator) teeth, which are spaced apart from one another by a respective groove in the laminated core and in the correct usage state carry a coil wound from a coil wire for generating a magnetic field, protrude radially inward in an annular laminated core with inner grooves. In contrast, stators are also known which are formed from so-called teeth chains. The laminated core is here folded up between the individual teeth, wound in the open state, and then joined together into the stator ring.

The coils formed on the individual teeth, depending on the design of electric motor, are for example connected alternately with two or also three phases of an electrical network. Connection usually takes place (mostly indirectly via motor electronics) via an end face of the stator on which the corresponding motor electronics are also arranged. Various types of insulation are known for preventing an electrical short between the coil wire and the laminated core. Usually however, independently of the insulation along the grooves in the laminated core—at least in an annular laminated core—a so-called insulating end disc is arranged on the end faces. This can be pushed on, molded on or over-molded, together with an insulation of the grooves and teeth, as a body around the stator lamination stack. On the connection side, i.e., on the side at which the coils are contacted and the motor electronics are arranged, the insulating end disc has so-called terminating domes, i.e., axially projecting protrusions on which the coil wire can be fixed for the so-called termination. “Termination” means the routing of the coil wire to the contact point and/or between at least two coils assigned to the same phase. Usually, contacting devices, e.g. receivers for so-called insulation displacement contacts in which the coil wire for contacting the motor electronics is attached, are also arranged on the insulating end disc. The smaller the electric motor and hence also the stator, the less installation space however remains on the insulating end disc for the terminating domes and/or the contacting devices, so that these must be made smaller and hence have lower mechanical strength.

### SUMMARY OF THE INVENTION

The invention is based on the object of providing an improved method of forming a stator winding, an improved stator, and an improved electric motor.

With the above and other objects in view there is provided, in accordance with the invention, a method of forming a stator winding of an annular laminated core for an electric motor, the method comprising:
providing a stator lamination stack of the annular laminated core with an insulating end disc, the insulating end disc having a plurality of terminating domes formed thereon protruding in an axial direction of the annular laminated core;
wrapping stator teeth protruding in a radial direction with a winding wire, to form a respective coil on each of the stator teeth;
routing the winding wire between two respective coils that are assigned to the same phase and/or for connecting the or each correspondingly assigned coil to motor electronics of the electric motor to the insulating end disc; and
laying the winding wire around respective terminating domes to form fixing loops for fixing the winding wire, and also routing the winding wire radially outside the terminating domes and radially inside the terminating domes.

In other words, the objects of the invention are achieved by forming a stator winding of an annular laminated core (or stator for short) for an electric motor, wherein: a stator lamination stack of the annular laminated core is equipped with an insulating end disc on which a plurality of terminating domes are formed protruding in the axial direction. Stator teeth protruding in the radial direction (in particular in the form of protrusions from the stator lamination stack) are wrapped with a winding wire, forming a respective coil. The winding wire between two coils assigned to the same phase and/or for connecting the or each correspondingly assigned coil to motor electronics is routed on the insulating end disc. In other words, the winding wire runs between such coils or from one coil to a contacting point with the motor electronics on, e.g. along, the insulating end disc. In addition to a number of fixing loops each laid around a terminating dome for fixing the winding wire, the winding wire is routed radially on the outside and also radially on the inside of the terminating domes. I.e., in addition to these fixing loops which are laid around a terminating dome over at least 360 degrees, and hence also have a loop portion arranged radially on the inside of the terminating dome, the winding wire of at least some coils (in particular between two coils or from one coil to a contacting point) runs on the outside and/or the inside of the terminating domes. Thus the winding wire of a coil (or coil group) may be routed either only radially on the outside or radially on the inside. Preferably, the winding wire switches between these route types, i.e., runs around several terminating domes on the outside and “jumps” others, in particular several, on the inside.

Thus installation space radially inside the terminating domes is used. In this way, undesired wire crossovers can be avoided. Also, in particular with a comparatively slender insulating end disc, installation space outside the terminating domes can be saved or used otherwise, e.g. such that in some cases, the terminating domes can be designed larger.

The annular laminated core (or stator) according to the invention is preferably produced by means of the method according to the invention described here and below, and configured and provided for use in an electric motor. For this, the stator comprises the stator lamination stack and the insulating end disc on which the terminating domes are formed and which is placed on the end face of the stator lamination stack. The stator also has a plurality of the above-mentioned coils which are wound by means of a winding wire on the stator teeth protruding in the radial direction. The winding wire between two coils assigned to the same phase and/or for connecting the or each correspondingly assigned coil to motor electronics is routed on the insulating end disc. In addition to the number of fixing loops each laid around a terminating dome for fixing the winding wire, the winding wire is routed radially outside and also radially inside the terminating domes.

The electric motor according to the invention has the stator described herein and below.

The stator and the electric motor thus both have the features and advantages described here and below in the context of the method, and in particular the resulting physical features and advantages.

The term “circumferential direction” as used herein means in particular the direction tangential to the (preferably approximately) circular-annular stator lamination stack (and to the rotational axis arranged centrally in the stator, or the axis of a rotor arranged rotatably therein in the correct final production state). The term “radial direction” accordingly means a direction running perpendicularly to the rotational axis. The axial direction thus designates a direction running parallel to, or along the rotational axis.

Preferably, the terminating domes are arranged along a circle ring line on the insulating end disc. In a suitable method variant, the winding wire is routed as a circle chord radially inside the terminating domes, i.e., in particular in a straight line.

Preferably, the winding wire is routed radially on the inside from one of the terminating domes to another. These two terminating domes here in particular serve as the start and end points of the—preferably above-mentioned—circle chord described by the winding wire. Optionally, the winding wire is fixed to one or both of these two terminating domes by wrapping around said terminating dome.

For example, the winding wire runs radially inside the ends, facing away from one another in the circumferential direction, of at least two adjacent terminating domes. Optionally, the winding wire jumps at least one terminating dome radially on the inside.

In particular, the winding wire is clamped freely between the two terminating domes. In other words, the winding wire does not lie on the insulating end disc in the region inside the terminating domes.

In contrast, when routed radially outside the terminating domes, the winding wire is routed on the end face of the insulating end disc facing away from the stator teeth. Optionally, at this point, a type of ring groove is cut into the insulating end disc, and/or the insulating end disc has at least partially a delimiting wall arranged radially on the outside.

The expression “routing partially radially on the inside” also means a meandering of the winding wire, i.e., an alternating course of the winding wire radially inside and radially outside directly adjacent terminating domes (hence a “slalom-like” course).

Additional features which are considered as characteristic for the invention are set forth in the appended claims.

Although the invention is illustrated and described herein as being embodied in a method for forming a stator winding, an annular laminated core, and an electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE FIGURE

The sole FIGURE of the drawing is a top view of an end face of an annular laminated core in an intermediate production stage.

### DETAILED DESCRIPTION OF THE INVENTION

Referring now to the FIGURE of the drawing in detail, there is shown a schematic top view onto an end face of an annular laminated core (stator) 1 of an electric motor. In the normal, correct usage state, the stator 1 is inserted, usually pressed, into a housing of the electric motor. The stator 1 is formed by a stator lamination stack 2 which has stator laminations stacked on top of one another along an axis A. Radially on the inside relative to the axis A, a plurality of grooves 4 are cut into these stator laminations and hence also into the lamination stack 2. Protrusions of the stator lamination stack 2, which protrude radially inward between the grooves 4 from a ring closed in a circumferential direction U, are hereinbelow referred to as stator teeth, or, simply, “teeth 6.” So-called pole shoes 8 (or pole shoe tips) are formed radially on the inside of these teeth 6. These have an edge which points towards the axis A and forms a circle ring portion, and in the correct usage state is arranged with a slight air gap from a rotor, which is received inside the stator 1 so to be rotatable about the axis A. The FIGURE illustrates an intermediate production stage of the stator 1.

In order to be able to build up a magnetic field necessary for the operation of the electric motor, the teeth 6 are wrapped with a winding or coil wire 10 so that each tooth 6 carries an assigned coil 12. This is also known as a concentrated winding. In order to achieve the maximum possible electrical power capacity, the individual turns of the wire must lie as closely together as possible.

In the exemplary embodiment shown, the stator 1 has twelve teeth 6 (and hence also twelve poles). Multiple coils 12 are connected together; in particular, the winding wire 10 is routed between the corresponding teeth 6 along a so-called insulating end disc 14, which in the present exemplary embodiment is placed onto the stator lamination stack 2 as a separate component. The insulating end disc 14 here carries several “terminating domes 16”, i.e., axially extended columns or protrusions around which the winding wire 10 is routed in order to maintain its tension and prevent a loosening of the coils 12.

In the present exemplary embodiment, the stator 1 is so small that, in the region of the ring of the stator lamination stack 2, there is insufficient space for contact points into which the winding wire 10 could be laid. For this reason, after the formation of the coils 12 and hence also after the termination of the winding wire 10 along the insulating end disc 14, a further component—here a contacting ring—is placed onto the stator lamination stack 2. The contacting ring comprises receivers for the winding wire 10 and for insulation displacement contacts.

In principle, the winding wire 10 of the coils 12 is routed outside the terminating domes 16. In order, however, to keep crossovers of the winding wire 10 of different coils 12 on the insulating end disc 14 to a minimum, the winding wire 10 is also routed partially radially inside the terminating domes 16. Firstly, for this—and also for its fixing and clamping—the winding wire 10 meanders partially around the terminating domes 16. Secondly, radially inside the terminating domes 16, the winding wire 10 is also “tensioned” at some points between (at least) two or even three terminating domes 16. Here, the winding wire 10 forms a respective circle chord 20 which runs between the ends of two terminating domes 16 facing away from one another in the circumferential direction U. The meandering of the winding wire 10 around the terminating domes 16 adjacent to the circle chord 20 is also sufficient to clamp the circle chord 20. This routing of the wire partially radially inside the terminating domes 16 also saves installation space in the region of the insulating end disc 14.

It will be understood that the subject of the invention is not restricted to the above-described exemplary embodiment. Rather, further embodiments of the invention may be derived from the above description by those of skill in the pertinent art.

The following is a summary list of reference numerals and the corresponding structure used in the above description of the invention:
1 Stator
2 Stator lamination stack
4 Groove
6 Tooth
8 Pole shoe
10 Winding wire
12 Coil
14 Insulating end disc
16 Terminating dome
20 Circle chord
A Axis
U Circumferential direction

1. A method of forming a stator winding of an annular laminated core for an electric motor, the method comprising:
providing a stator lamination stack of the annular laminated core with an insulating end disc, the insulating end disc having a plurality of terminating domes formed thereon protruding in an axial direction of the annular laminated core;
wrapping stator teeth protruding in a radial direction with a winding wire, to form a respective coil on each of the stator teeth;
routing the winding wire between two respective coils that are assigned to the same phase and/or for connecting the or each correspondingly assigned coil to motor electronics of the electric motor to the insulating end disc; and
laying the winding wire around respective terminating domes to form fixing loops for fixing the winding wire, and also routing the winding wire radially outside the terminating domes and radially inside the terminating domes.

2. The method according to claim 1, wherein the terminating domes are arranged along a circle ring line on the insulating end disc, and wherein the winding wire is routed as a circle chord radially inside the terminating domes.

3. The method according to claim 2, which comprises routing the winding wire radially on the inside from one of the terminating domes to another of the terminating domes.

4. The method according to claim 3, wherein the winding wire extends freely between the two terminating domes.

5. The method according to claim 2, which comprises routing the winding wire radially outside the terminating domes on an end face of the insulating end disc facing away from the stator teeth.

6. An annular laminated core for an electric motor, the laminated core comprising:
a stator lamination stack formed with a plurality of radially protruding stator teeth;
an insulating end disc disposed on an end face of said stator lamination stack, said insulation end disc having a plurality of axially protruding terminating domes formed thereon; and
a plurality of coils formed by winding wire wound on the radially protruding stator teeth;
wherein said winding wire is routed between two coils assigned to the same phase and/or for connecting the or each correspondingly assigned coil to motor electronics of the electric motor, and to said insulating end disc; and
wherein said winding wire, in addition to forming a number of fixing loops each laid around a terminating dome for fixing said winding wire, is routed radially outside said terminating domes and also radially inside said terminating domes.

7. An electric motor, comprising an annular laminated core according to claim 6.
